(19) United States
(12) Patent Application Publication
(10) Pub. No.: US 2026/0271083 A1
(43) Pub. Date: Sep. 10, 2026

(54) SYSTEMS AND METHODS FOR FURTHER BANDWIDTH REDUCTION IN ENHANCED REDUCED CAPABILITY COMMUNICATIONS

(71) Applicant: APPLE INC., Cupertino, CA (US)

(72) Inventors: Naveen Kumar R Palle Venkata, San Diego, CA (US); Alexander Sirotkin, Hod Hasharon (IL); Peng Cheng, Beijing (CN); Ping-Heng Kuo, London (GB); Yuqin Chen, Beijing (CN); Haijing Hu, Los Gatos, CA (US); Ralf Rossbach, Munich (DE); Zhibin Wu, Los Altos, CA (US); Fangli Xu, Beijing (CN)

(21) Appl. No.: 19/167,602

(22) PCT Filed: May 11, 2023
(86) PCT No.: PCT/CN2023/093577

§ 371 Date: Sep. 22, 2025

(51) Int. Cl. H04W 74/0833; H04W 8/22; H04W 60/04; H04W 72/0457; H04W 72/20

(52) U.S. Cl. CPC H04W 74/0833; H04W 8/22; H04W 60/04; H04W 72/0457; H04W 72/20

(57) ABSTRACT

Apparatus, systems, and methods provide for a user equipment (UE) to communicate with a wireless network. The UE receives, from a base station, an indication that the wireless network supports enhanced reduced capability (eRedCap) UE operation. The UE indicates, to the base station, an eRedCap type associated with the UE.

### TECHNICAL FIELD

This application relates generally to wireless communication systems, including methods for identifying and managing enhanced reduced capability (eRedCap) communications in a wireless network.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

Reduced capability (RedCap) devices may be used in 3GPP networks. For example, RedCap devices may be used for industrial wireless sensors, video surveillance, or wearable devices. With respect to non-RedCap devices, RedCap devices may have less receive/transmit antennas, reduced bandwidth, half-duplex frequency division duplexing (instead of full-duplex), relaxed UE processing time, and relaxed UE processing capability.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network environment in accordance with certain embodiments.

FIG. 2 illustrates an RA procedure that may be used to signal eRedCap capabilities in accordance with certain embodiments.

FIG. 3 illustrates a signaling operation in accordance with certain embodiments.

FIG. 4 illustrates BWP configurations in which different BWPs are configured with different eRedCap notification procedures in accordance with certain embodiments.

FIG. 5 illustrates a MAC subheader with a reserved bit that may be used in accordance with certain embodiments.

FIG. 6 illustrates a flowchart of a method for a UE to communicate with a wireless network in accordance with certain embodiments.

FIG. 7 illustrates a flowchart of a method for operating a base station in a wireless network in accordance with certain embodiments.

FIG. 8 illustrates a flowchart of a method for a UE to communicate with a wireless network in accordance with certain embodiments.

FIG. 9 illustrates a flowchart for operating a base station in a wireless network in accordance with certain embodiments.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

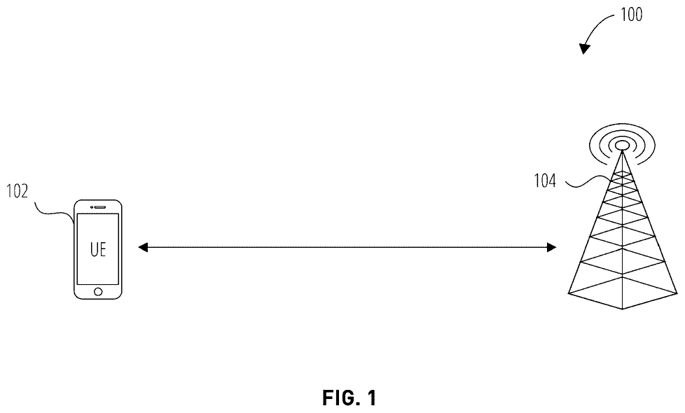

FIG. 1 illustrates a network environment 100 in accordance with certain embodiments. The network environment 100 may include a UE 102 and a base station 104. The base station 104 may provide one or more wireless access cells through which the UE 102 may communicate with the base station 104. The base station 104 may provide an air interface compatible with 3GPP technical specifications, such as those that define 5G NR or later system standards. The base station 104 may provide the UE 102 access to other networks, for example, a 3GPP core network, a data network, etc. Depending on the technology of the access and core network, the base station 104 may be referred to as an eNB, gNB, an ng-NB, etc.

The UE 102 may engage the base station 104 through a random access (RA) procedure. The RA procedure may be triggered based on a number of events including, for example, initial access from a radio resource control (RRC) idle state, RRC connection reestablishment or resume procedure, small data transmissions in an RRC inactive state, etc. The RA procedure may be a 4-step RA type or a 2-step RA type. Either the 4-step RA type or the 2-step RA type may use contention-based random access (CBRA) or contention-free random-access (CFRA). In general, the RA procedure may be similar to that described in 3GPP 38.300 v17.3.0 (2023-01-13), except as otherwise described herein.

To reduce device complexity and energy consumption, 3GPP Release 17 (Rel-17) networks include provisions for reduced capability (RedCap) UEs. These RedCap UEs have less transmit/receive capabilities as compared to the non-RedCap UEs. For example, a RedCap UE may have a reduced number of receive/transmit antennas (for example, less than four), UE bandwidth reduction (for example, up to 20 MHz), half-duplex frequency division duplexing, a relaxed UE processing time, or a relaxed UE processing capability.

To enable further reduction of device complexity and energy consumption, for example in 3GPP Release 18 (Rel-18) and beyond, enhanced reduced capability (eRedCap) UEs may be provided with further reduced complexity as compared to Redcap UEs. For example, an eRedCap UE operating in FR1 may have further UE baseband (BB) bandwidth reduction and UE peak data rate reduction.

The BB bandwidth reduction may restrict the eRedCap UE to a BB bandwidth no greater than 5 megahertz (MHz) for physical downlink shared channel (PDSCH) transmissions (both unicast and broadcast) and physical uplink shared channel (PUSCH) transmissions. The radio-frequency (RF) bandwidth for uplink (UL) and downlink (DL) may be larger, for example, 20 MHz (similar to RedCap UEs). Further, other physical channels in signals may still be allowed to use a bandwidth part (BWP) up to a 20 MHz maximum UE RF plus BB bandwidth.

A RedCap UE may have a constraint (vLayers*Qm*f≥4) for peak data rate reduction, where vLayers is a number of transmission layers, Qm is a modulation order, and f is a scaling factor. An eRedCap UE may relax this constraint be vLayers*Qm*f≥1.

An eRedCap UE may operate with either 15 kilohertz (kHz) subcarrier spacing (SCS) or 30 kHz SCS.

In some embodiments, only one type of eRedCap UE may be defined. This may further reduce UE complexity. However, in other embodiments, more than one type of eRedCap UE may be defined.

To facilitate incorporation of eRedCap UEs into new cellular networks (for example, networks operating consistent with 3GPP Rel-18 and later), an existing UE capability framework may be used. Changes to capability signaling may be specified as needed. However, by default in certain embodiments, all UE capabilities applicable to a RedCap UE as defined by 3GPP Rel-17 may be applicable to eRedCap UEs unless othe1wise specified.

For 3GPP Rel-18, there may be different options for UE bandwidth (BW) reduction, UE peak rate (PR) reduction, and a relaxed UE processing timeline (PT). For UE BW reduction, a first option (option BW1) includes both RF and BB bandwidths are 5 MHz for UL and DL, a second option (option BW2) includes 5 MHz BB bandwidth for all signals and channels with 20 MHz RF bandwidth for UL and DL, and a third option (option BW3) includes 5 MHz BB bandwidth only for the PDSCH (for both unicast and broadcast) and the PUSCH with a 20 MHz RF bandwidth for UL and DL, wherein other physical channels and signals are still allowed to use a BWP up to the 20 MHz maximum UE RF+BB bandwidth.

For UE PR reduction, a first option (option PR1) includes relaxation of the constraint in the current specification, a second option (option PR2) includes restriction of maximum transport block size (TBS) for PDSCH and PUSCH (e.g., 15 KHz SCS: 10000 bits; 30 kHz SCS: 5000 bits), and a third option (option PR3) includes restriction of the maximum number of physical resource blocks (PRBs) for PDSCH and PUSCH (e.g., 15 KHz SCS: 25 RBs; 30 kHz SCS: 11 RBs).

For relaxed UE PT, a first option (option PT1) includes relaxing PDSCH and PUSCH processing time N1/N2 to two times, and a second option (option PT2) includes relaxation of channel state information (CSI) processing time Z and Z′ to two times.

By way of example only, Table 1, Table 2, and Table 3 show estimated average cost reductions for 3GPP Rel-18 as compared to 3GPP Rel-17 for UE BW reduction options, UE PR reduction options, and relaxed UE PT options. See, e.g., 3GPP Technical Report (TR) 38.865. The comparisons are shown for a single reception (Rx) full-duplex (FD) frequency division duplexing (FDD), half-duplex (HD) FDD, and time division duplexing (TDD).

TABLE 1

| Cost saving relative to Rel-17 | FD-FDD | TDD | HD-FDD |
|---|---|---|---|
| RedCap (20 MHz BW) | (1 Rx) | (1 Rx) | (1 Rx) |
| Option BW1 | 11.9% | 11.3% | 14.1% |
| Option BW2 | 9.2% | 8.1% | 11.9% |
| Option BW3 | 8.0% | 7.7% | 8.9% |

TABLE 2

| Cost saving relative to Rel-17 | FD-FDD | TDD | HD-FDD |
|---|---|---|---|
| RedCap (20 MHz BW) | (1 Rx) | (1 Rx) | (1 Rx) |
| Option PR1 | 4.1% | 4.0% | 5.0% |
| Option PR2 | 4.3% | 4.2% | 5.1% |
| Option PR3 | 7.1% | 6.7% | 8.1% |

TABLE 3

| Cost saving relative to Rel-17 | FD-FDD | TDD | HD-FDD |
|---|---|---|---|
| RedCap (20 MHz BW) | (1 Rx) | (1 Rx) | (1 Rx) |
| Option BW1 + PT1 | 12.4% | 11.6% | 14.3% |
| Option BW3 + PT1 | 8.7% | 7.8% | 10.2% |
| Option PR1 + PT1 | 5.4% | 4.9% | 6.6% |

For PUSCH and PDSCH for eRedCap, a 3GPP Rel-18 eRedCap UE capable of 20 MHz+PR1 and Rel-18 eRedCap UE capable of BW3/PR3+PR1 may be designed or targeted to the same peak data rate (i.e., 10 Mbps). A peak data rate of a Rel-18 eRedCap UE capable of 20 MHz+PR1 and a Rel-18 eRedCap UE capable of BW3/PR3+PR1 may be the same including unicast and broadcast respectively.

The PRB processing capability of a Rel-18 eRedCap UE capable of 20 MHz+PR1 may not be limited to 25 PRBs for 15 kHz SCS and 12 PRBs for 30 kHz SCS and may correspond to a PRB size corresponding to 20 MHz. In certain systems, this may be the only difference between a Rel-18 eRedCap UE capable of 20 MHz+PR1 and a Rel-18 eRedCap UE capable of BW3/PR3+PR1 and vLayers·Qm·f in order to have the same peak rate.

In certain systems, the initial access procedure of a Rel-18 eRedCap UE capable of 20 MHz+PR1 may be the same as that for a Rel-18 eRedCap UE capable of BW3/PR3+PR1.

Referring again to FIG. 1, if the UE 102 is an eRedCap UE, which may be assumed for purposes of the embodiments described herein, the base station 104 may need to restrict scheduling of PUSCH/PDSCH transmissions on PRB allocations depending on the eRedCap type. For example, if the UE 102 is a first eRedCap type capable of 20 MHz with BW3/PR3+PR1 options, the base station 104 may apply different restrictions (e.g., scheduling of PUSCH/PDSCH transmissions on PRB allocations that do not exceed 5 MHz) than the restrictions if the UE 102 is a second eRedCap type capable of 20 MHz+PR1 options.

The restrictions may apply during the RA procedure, for example, with respect to a message 3 (Msg3) PUSCH. However, in legacy networks, information about the capabilities of a UE (including RedCap capabilities) are not transferred to the network until a much later time. Typically, a UE will camp on a cell, perform an RA procedure, enter into connected mode, receive downlink control information (DCI) that schedules resources for the UE to transmit uplink registration information, and then engage in a UE capability request response. Further, even after an RA procedure, the base station 104 may need to ensure that the UE is not scheduled more than 5 MHz in terms of PRBs for eRedCap, at least for eRedCap UEs implementing BW3/PR3 options.

Embodiments of the present disclosure provide signaling to inform the base station 104 that the UE 102 is an eRedCap UE and/or the eRedCap type for the UE 102. The signaling may be in the RA procedure and/or in a UE capability message. Thus, the base station 104 may ensure that subsequent scheduling does not exceed the limited capabilities of the UE 102.

### UE Capability

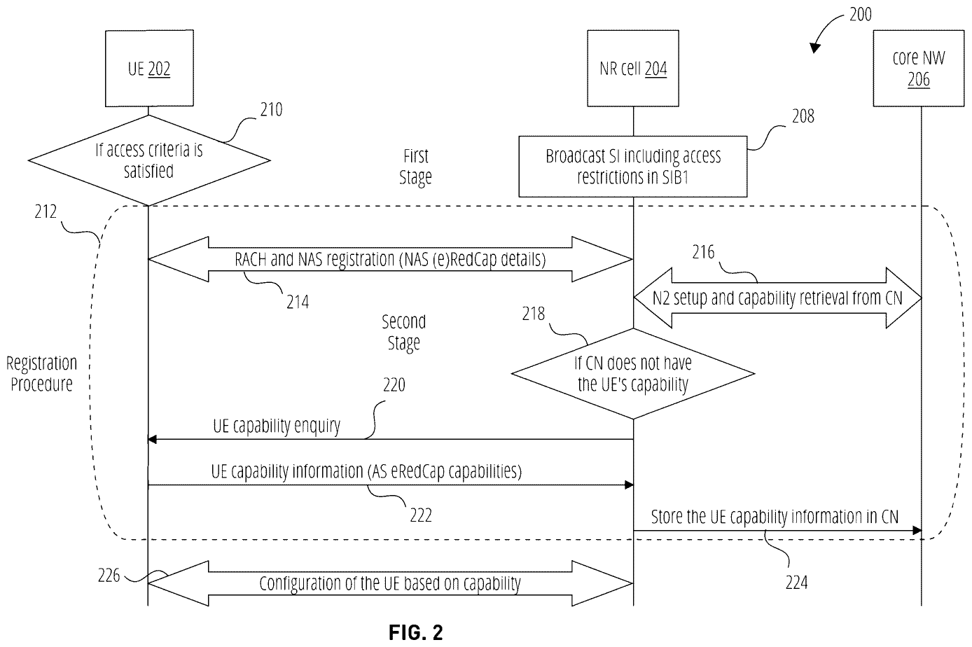

FIG. 2 illustrates an RA procedure 200 that may be used to signal eRedCap capabilities in accordance with certain embodiments. As shown, a UE 202, an NR cell 204 (e.g., a base station or gNB), and a core NW 206 participate in the RA procedure 200. In a first stage, the NR cell 204 broadcasts 208 system information (SI) including access restrictions in a first system information block (SIB1) that the UE 202 uses to determine 210 whether access criteria is satisfied to access the wireless network through the NR cell 204. The SI information broadcast by the NR cell 204 may include an indication that the wireless network supports eRedCap UEs.

If the access criteria is satisfied, including a determination that the wireless network supports eRedCap UEs, the RA procedure 200 enters a second stage wherein the UE 202 performs a registration procedure 212 with the NR cell 204, which includes random access channel (RACH) and non-access stratum (NAS) 214. In certain embodiments, the RACH and NAS registration may include NAS RedCap and/or eRedCap details. The NR cell 204 communicates 216 with the core NW 206 to setup an N2 interface and to retrieve any UE capability information stored by the core NW 206 (also referred to as CN). The NR cell 204 then determines 218 whether the core NW 206 has the UE's capability and/or whether the UE capability information includes eRedCap information with eRedCap type.

If the core NW 206 is unable to provide the UE's capability and/or the UE capability information does not include the eRedCap information with eRedCap type, the NR cell 204 sends a UE capability enquiry message 220 to the UE 202 and receives a UE capability information message 222 in response. The NR cell 204 then sends a message 224 to store the UE capability information in the core NW 206, which may be part of a network UE capability container. In certain embodiments, the UE capability information message 222 includes eRedCap capabilities (e.g., an indication that the UE 202 is an eRedCap UE and/or the eRedCap type of the UE 202). After the registration procedure 212, the NR cell 204 performs configuration 226 of the UE 202 based on the UE's capability.

In certain embodiments, the UE 202 reports the eRedCap type in a UE-capability information element (IE). In certain such embodiments, a default assumption is that UE 202 has a type with the PR1 option and the reduced PR3/BW3 option is to be explicitly reported by the UE 202. For example, for a first eRedCap type comprising an eRedCap UE (e.g., 20 MHz)+BW3/PR3+PR1 and a second eRedCap type comprising an eRedCap UE+PR1, abstract syntax notation 1 (ASN1) code for a UE-capability IE is given by:

UE-NR-Capability-v1800 ::= SEQUENCE {

| | |
|---|---|
| redCapParameters-r17 | RedCapParameters-r18 OPTIONAL, |
| nonCriticalExtension | SEQUENCE { } OPTIONAL |

```
}
RedCapParameters-r18 ::= SEQUENCE {
    -- eRedCap UE
supportOfeRedCap-r18 CHOICE {
        eRedCapPR1 ENUMERATED {supported},
        eRedCapBW3PR3 ENUMERATED {supported}
      } OPTIONAL -- Absence implies the eRedCap UE is PR1 type
}.
```

In another example, ASN1 code for a UE-capability IE is given by

UE-NR-Capability-v1800 ::= SEQUENCE {

| | |
|---|---|
| redCapParameters-r17 | RedCapParameters-r18 OPTIONAL, |
| nonCriticalExtension | SEQUENCE { } OPTIONAL |

```
}
RedCapParameters-r18 ::= SEQUENCE {
      -- eRedCap UE
    eRedCapBW3PR3 ENUMERATED {supported} OPTIONAL -- Absence
implies the eRedCap UE is PR1 type
  }.
```

Irrespective of whether the UE may be identified at the initial access (e.g., as disclosed in certain embodiments herein), the UE capability may be provided by the UE using the existing UE capability network (NW) container. During eRedCap UE handover, the initial access based identification may not be sufficient and the target gNB needs to know the type of eRedCap UE it is handling. No new inter-node exchange may be needed, according to certain embodiments, as the NR capability container is already exchanged across gNB Centralized Units (CUs), and between the gNB and the Access and Mobility Management Function (AMF) (e.g., N2 interface). The absence of this capability may imply that the gNB assumes that the eRedCap UE is type PR1.

UE Identification of Base Stations Supporting eRedCap

An impact of having two or more eRedCap types (e.g., eRedCap UE+PR1 and eRedCap UE+BW3/PR3+PR1) is that the network knowledge of BW3 at access time helps the network to not schedule >5 MHz worth of PRBs to the UE. On the other hand, any eRedCap UE supporting the gNB may schedule <5 MHz worth of PRBs to all of the UEs until the UE capability is retrieved. This implies that the gNB may not need to be aware of the particular eRedCap type at initial access. However, it is useful for the gNB to know at initial access whether the U is an eRedCap UE or not.

Thus, in certain embodiments, the gNBs supporting eRedCap signal such support on broadcast channels. Further, in certain such embodiments, gNBs that support eRedCap also support at least the first eRedCap type comprising an eRedCap UE+BW3/PR3+PR1 and the second eRedCap type comprising an eRedCap UE+PR1. Accordingly, an eRedCap UE assumes that a gNB that broadcasts support of eRedCap will supports both eRedCap UE+PR1 and eRedCap UE+BW3/PR3+PR1 versions of eRedCap. No additional signaling in broadcast is needed for explicit support of each of the versions. Also, an eRedCap UE with the type comprising BW3/PR3+PR1 may assume that the gNB schedules PDSCH/PUSCH with <5 MHz PRBs during initial access before the UE capability is reported. After capability access, for the eRedCap UE with the type comprising BW3/PR3+PR1, the network limits PDSCH/PUSCH with <5 MHz PRBs.

Base Station Identification of eRedCap and/or eRedCap Type

In certain embodiments, a UE may use a Msg3 in an RA procedure to indicate that it is an eRedCap UE, regardless of the eRedCap type. For example, the UE may include an eRedCap indication in a media access control (MAC) control element (CE) that is included in the Msg3 transmitted to the base station. In some embodiments, the eRedCap indication may be a value indicated in a logical channel identifier (LCID) field of the MAC CE. For example, Table 6.2.1-2 Values of LCID for UL-SCH of 3GPP Technical Specification (TS) 38.321 may be modified as shown below in Table 4 to accommodate the eRedCap indication.

TABLE 4

| Codepoint/Index | LCID values |
|---|---|
| 0 | CCCH of size 64 bits (referred to as “CCCH1” in TS 38.331), |
| | except for a RedCap UE or eRedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” in TS 38.331) |
| | RedCap UE |
| 36 | CCCH of size 64 bits (referred to as “CCCH1” in TS 38.331) |
| | for a RedCap UE |
| 37 | CCCH of size 48 bits (referred to as “CCCH” in TS 38.331) |
| | for a eRedCap UE which cannot support more than 5 MHz |
| | for UL SCH |
| 38 | CCCH of size 64 bits (referred to as “CCCH1” in TS 38.331) |
| | for a eRedCap UE which cannot support more than 5 MHz |
| | for UL SCH |
| 39-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS 38.331), |
| | except for a RedCap UE or eRedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Thus, the UE may include a value corresponding to codepoint/index 37 if the size of the UL common control channel (CCCH) MAC service data unit (SDU) of Msg3 that carries the LCID is 48 bits or a value corresponding to codepoint/index 38 if the size of the UL CCCH MAC SDU of Msg3 that carries the LCID is 64 bits. In either case, the base station would understand that the UE is operating as an eRedCap UE and should be scheduled with an UL/DL shared channel accordingly.

In some embodiments, the modification to codepoints/indexes 35/36 would only be included if the modifications to codepoints/indexes 37/38 are not added. This may be the case if the base station supports both RedCap and eRedCap and plans to schedule defensively even for RedCap (until the actual capabilities are received). In other embodiments, the modifications to codepoints/indexes 35/36 would be added with the modifications to codepoints/indexes 37/38. This may allow a legacy base station that does not implement the updated eRedCap to treat an eRedCap UE as a RedCap UE and not handle the UE. Base stations that have implemented the update eRedCap may additionally look to the codepoints/indexes 37/38 to determine whether the UE is a RedCap or eRedCap UE. If a base station only supports RedCap and not eRedCap, an eRedCap may not camp on its cell.

A drawback of the base station not knowing the UE type at the initial access, is that the base station may limit the PDSCH/PUSCH to <5 MHz even for PR1 UEs. Thus, certain embodiments extend the LCID based identification so that an eRedCap UE reports its eRedCap type using the LCID. For example, as shown in Table 5, codepoints/indexes 37/38 may be used for an eRedCap UE that cannot support more than 5 MHz for UL SCH, and codepoints/indexes 39/40 may be used for a PR1 eRedCap UE.

TABLE 5

| Codepoint/Index | LCID values |
|---|---|
| 0 | CCCH of size 64 bits (referred to as “CCCH1” in TS 38.331), |
| | except for a RedCap UE or eRedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” in TS 38.331) |
| | for a RedCap UE |
| 36 | CCCH of size 64 bits (referred to as “CCCH1” in TS 38.331) |
| | for a RedCap UE |
| 37 | CCCH of size 48 bits (referred to as “CCCH” in TS 38.331) |
| | for a eRedCap UE which cannot support more than 5 MHz |
| | for UL SCH |
| 38 | CCCH of size 64 bits (referred to as “CCCH1” in TS 38.331) |
| | for a eRedCap UE which cannot support more than 5 MHz |
| | for UL SCH |
| 39 | CCCH of size 48 bits (referred to as “CCCH” in TS 38.331) |
| | for a PR1 eRedCap UE as specified in TS 38.306 |
| 40 | CCCH of size 64 bits (referred to as “CCCH1” in TS 38.331) |
| | for a PR1 eRedCap UE as specified in TS 38.306 |
| 41-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS 38.331), |
| | except for a RedCap UE or eRedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

LCID space (i.e., available codepoints/indexes) in certain systems may be limited. For example, using Table 5 would leave only two reserved values (at codepoints/indexes 41-42). Thus, certain embodiments herein use extended LCIDs (eLCIDs) for eRedCap UEs. For example, Table 6.2.1-2b Values of One-Octet eLCID for UL-SCH of 3GPP TS 38.321 may be modified as shown below in Table 6 to accommodate the eRedCap type indications. In this example, codepoints 225/226 are used for a PR1 eRedCap UE and codepoints 227/228 are used for an eRedCap UE that cannot support more than 5 MHz for UL SCH.

TABLE 6

| Codepoint | Index | LCID values |
|---|---|---|
| 0 to 224 | 64 to 288 | Reserved |
| 225 | 289 | CCCH of size 48 bits (referred to as |
| | | “CCCH” in TS 38.331) for a PR1 eRedCap |
| | | UE as specified in TS 38.306 |
| 226 | 290 | CCCH of size 64 bits (referred to as |
| | | “CCCH1” in TS 38.331) for a PR1 eRedCap |
| | | UE as specified in TS 38.306 |
| 227 | 291 | CCCH of size 48 bits (referred to as |
| | | “CCCH” in TS 38.331) for a eRedcap UE |
| | | which cannot support more than 5 MHz for |
| | | UL SCH |
| 228 | 292 | CCCH of size 64 bits (referred to as |
| | | “CCCH1” in TS 38.331) for a eRedcap UE |
| | | which cannot support more than 5 MHz for |
| | | UL SCH |
| 229 | 293 | Enhanced Multiple Entry PHR for multiple |
| | | TRP (four octets Cᵢ) |
| 230 | 294 | Enhanced Multiple Entry PHR for multiple |
| | | TRP (one octets Cᵢ) |
| 231 | 295 | Enhanced Single Entry PHR for multiple |
| | | TRP |
| 232 | 296 | Enhanced Multiple Entry PHR |
| | | (four octets Cᵢ) |
| 233 | 297 | Enhanced Multiple Entry PHR |
| | | (one octets Cᵢ) |
| 234 | 298 | Enhanced Single Entry PHR |
| 235 | 299 | Enhanced BFR (one octet Cᵢ) |
| 236 | 300 | Enhanced BFR (four octet Cᵢ) |
| 237 | 301 | Truncated Enhanced BFR (four octet Cᵢ) |
| 238 | 302 | Positioning Measurement Gap |
| | | Activation/Deactivation Request |
| 239 | 303 | IAB-MT Recommended Beam Indication |
| 240 | 304 | Desired IAB-MT PSD range |
| 241 | 305 | Desired DL Tx Power Adjustment |
| 242 | 306 | Case-6 Timing Request |
| 243 | 307 | Desired Guard Symbols for Case 6 timing |
| 244 | 308 | Desired Guard Symbols for Case 7 timing |
| 245 | 309 | Extended Short Truncated BSR |
| 246 | 310 | Extended Long Truncated BSR |
| 247 | 311 | Extended Short BSR |
| 248 | 312 | Extended Long BSR |
| 249 | 313 | Extended Pre-emptive BSR |
| 250 | 314 | BFR (four octets Cᵢ) |
| 251 | 315 | Truncated BFR (four octets Cᵢ) |
| 252 | 316 | Multiple Entry Configured Grant |
| | | Confirmation |
| 253 | 317 | Sidelink Configured Grant Confirmation |
| 254 | 318 | Desired Guard Symbols |
| 255 | 319 | Pre-emptive BSR |

In one embodiment, all eRedCap UEs may use the eLCID based identification, where an explicit type may be signaled and no legacy LCID may be used to signal eRedCap.

In one embodiment, an eRedCap UE does not set LCID with no extra signaling for codepoints/indexes 35 and 36.

In one embodiment, an eRedCap UE sets LCID codepoints/indexes 35 or 36 (as in legacy Rel-17 RedCap).

Because eLCID adds one more octet in size, the base station may provide a Msg3 UL grant with additional size. This may result in a reduction in coverage of the cell. Thus, in certain embodiments, the base station has the option to be defensive in scheduling or may determine whether or not it wants the UE to identify itself as an eRedCap UE or its eRedCap type. For example, the base station may use the RACH configuration to configure the UE for Msg3 based UE identification for conveying the type of eRedCap. If the UE is not so configured, the network may limit the UE to <5 MHz PRB scheduling.

In certain embodiments, since a coverage impact is present, the base station may configure whether or not the eLCID can be used for Msg3. The UE's actions may be based on the SIB RACH configuration. If configured, eLCID may be used for conveying the type of eRedCap. If not configured, the LCID based identification may be used by default by the UE.

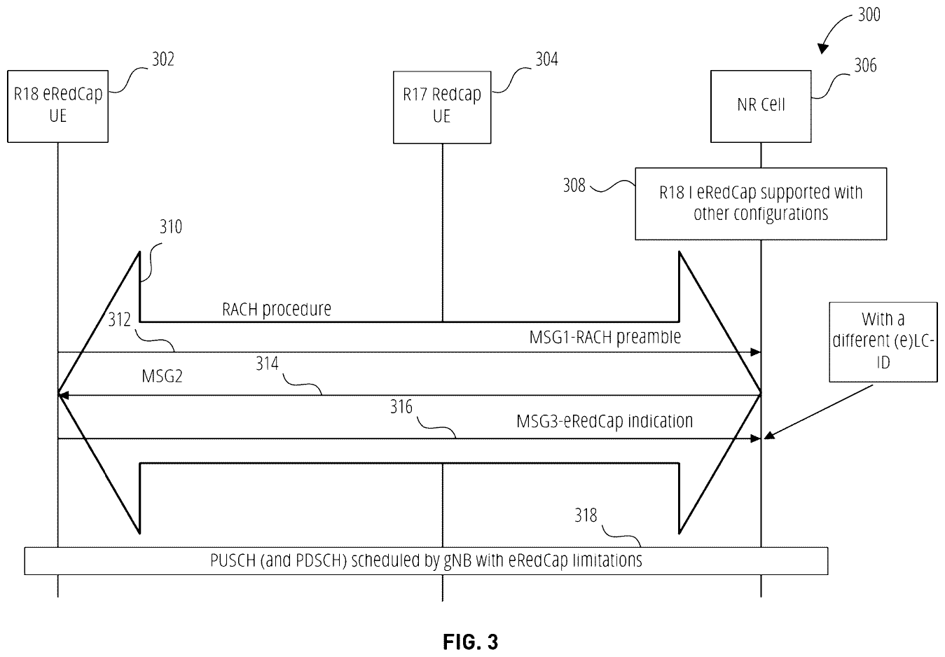

FIG. 3 illustrates a signaling operation 300 in accordance with some embodiments. The signaling operation 300 may be used by a Rel-18 eRedCap UE (shown as an R18 eRedCap UE 302) to inform an NR cell 306 (e.g., gNB or base station) that it is an eRedCap UE and/or its eRedCap type. The signaling operation 300 may also be used by a Rel-17 RedCap UE (shown as an R17 RedCap UE 304) to inform the NR cell 306 that it is a RedCap UE.

The signaling operation 300 may include, at 308, the NR cell 306 broadcasting that it supports RedCap UEs and/or eRedCap UEs with other configurations (e.g., the broadcasted message may indicate whether the eRedCap UEs should use LCID or eLCID to identify as an eRedCap UE and/or to indicate an eRedCap type.

The signaling operation 300 may further include an RA procedure 310. As illustrated, the RA procedure 310 may be a 4-step RA type procedure.

The RA procedure 310 may include, at 312, the R18 eRedCap UE 302 or R17 RedCap UE 304 transmitting a first message (Msg1) to the NR cell 306. The Msg1 may include a RACH preamble transmitted on physical random access channel (PRACH) resources. The RACH preamble may be randomly selected from a pool of shared RA preambles. At 314, the RA procedure may include the NR cell 306 responding to the Msg1 by transmitting a random-access response (RAR) in a second message (Msg2). The RAR may include an RA preamble identifier, timing alignment information, initial uplink grant, and temporary cell-radio network temporaly identifier (TC-RNTI). If the R18 eRedCap UE 302 or the R17 RedCap UE 304 receives a physical downlink control channel (PDCCH) with the RAR within a defined time window, and the RAR includes a preamble identifier that corresponds to the preamble transmitted in Msg1, the response is successful. The RA procedure 310 may then include, at 316, the R18 eRedCap UE 302 or the R17 RedCap UE 304 sending a scheduled uplink transmission over a PUSCH in a third message (Msg3). The third message may include an identifier (ID) for contention resolution. In a fourth step, if used, the NR cell 306 may send the contention resolution ID in a fourth message (Msg4) (not shown).

The R18 eRedCap UE 302 may use the RA procedure to indicate that it is an eRedCap UE and/or its eRedCap type using a different LCID or eLCID in the Msg3 at 316, as configured by the NR cell 306. The NR cell 306 may then use this information to schedule uplink and downlink shared channels (e.g., PUSCH/PDSCH) within eRedCap type limitations at 318. This may be done by, e.g., restricting the scheduled PRBs to have a bandwidth of 5 MHz or less.

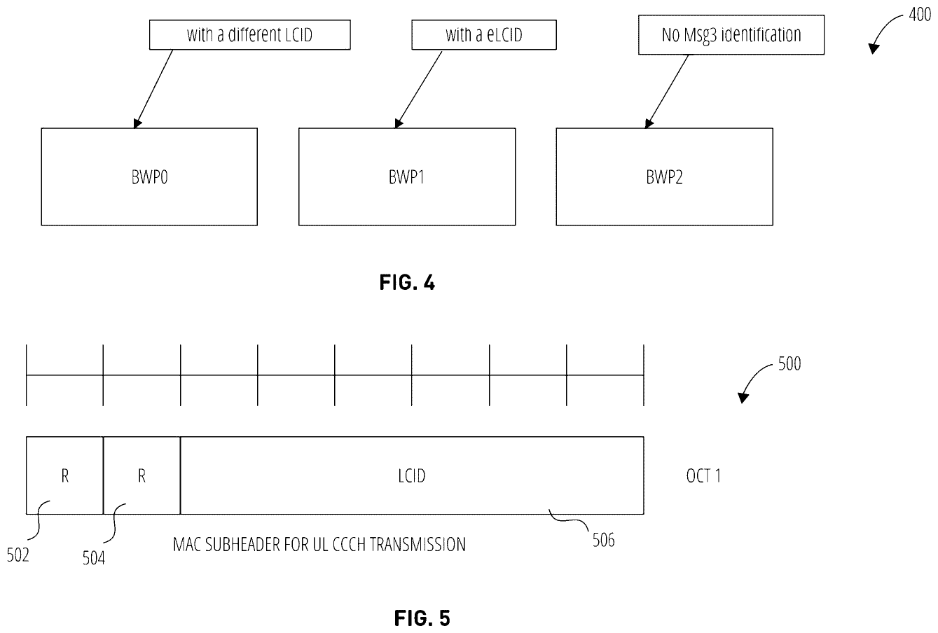

FIG. 4 illustrates BWP configurations 400 in which different BWPs are configured with different eRedCap notification procedures in accordance with certain embodiments. For example, BWP0 may be configured to with a different LCID for a UE to use to identify itself as a RedCap UE or an eRedCap UE, BWP1 may be configured to use eLCID for a UE to identify its eRedCap type, and BWP2 may be configured to not use Msg3 identification in a RA procedure. Other BWP-specific configurations may also be used, consistent with any of the embodiments disclosed herein.

FIG. 5 illustrates a MAC subheader 500 for UL CCCH transmission with a reserved bit that may be used to indicate a RedCap UE, an eRedCap UE, and/or an eRedCap type according to certain embodiments. The MAC subheader 500 is an octet (OCT) including a first reserved bit 502, a second reserved bit 504, and six LCID bits 506.

In one embodiment, one of the reserved bits is set to indicate an eRedCap UE. For Rel-17 RedCap UEs, the LCID values may not be set. Alternatively, for Rel-17 RedCap UEs, the LCID values may be set along with the reserved bit (e.g., use the 48 bit or 64 bit sizes).

In one embodiment, both reserved bits are set to indicate an eRedCap UE and to notify the size of the CCCH. For example, the first reserved bit 502 may be used to indicate a size of 48 bits and the second reserved bit 504 may be used to indicate a size of 64 bits. For Rel-17 RedCap UEs, the LCID values may not be set. Alternatively, for Rel-17 RedCap UEs, the LCID values may be set along with the reserved bits.

In certain embodiments, setting one of the reserved bits indicates a specific eRedCap type (e.g., the BW3 type).

### Example Processes

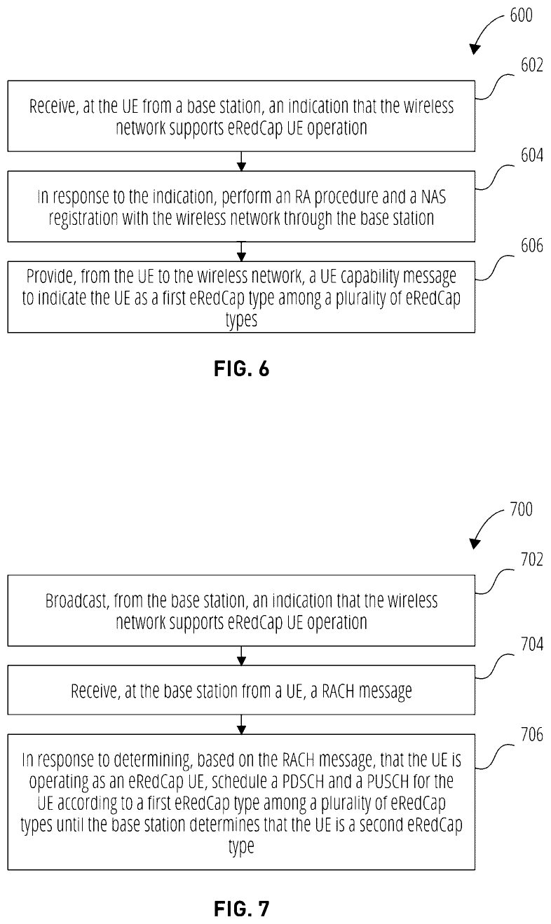

FIG. 6 illustrates a flowchart of a method 600 for a UE to communicate with a wireless network, according to embodiments herein. The method 600 includes receiving 602, at the UE from a base station, an indication that the wireless network supports eRedCap UE operation. The method 600 further includes performing 604, in response to the indication, an RA procedure and a NAS registration with the wireless network through the base station. The method 600 further includes providing 606, from the UE to the wireless network, a UE capability message to indicate the UE as a first eRedCap type among a plurality of eRedCap types.

In some embodiments of the method 600, the plurality of eRedCap types includes a second eRedCap type corresponding to a peak data rate reduction, and the first eRedCap type corresponds to the peak data rate reduction and a maximum bandwidth of 5 MHz for PRBs in a PDSCH or a PUSCH. In some such embodiments, in response to the indication from the base station that the wireless network supports the eRedCap UE operation, the UE assumes that the base station supports both the first eRedCap type and the second eRedCap type.

In some embodiments, the method 600 further comprises, during the RA procedure, indicating from the UE to the base station that the UE is operating as an eRedCap UE. In some such embodiments, at least until the UE provides the UE capability message to the base station, the UE assumes that the base station schedules a maximum bandwidth of 5 MHz for PRBs in a PDSCH or a PUSCH. Some such embodiments further comprise transmitting, from the UE to the base station during the RA procedure, an RACH message including a value in an LCID field of an MAC subheader, wherein the value is to indicate the UE is operating as the eRedCap UE. In certain such embodiments, the value in the LCID field corresponds to a CCCH with a size of 48 bits or 64 bits.

Embodiments contemplated herein include an apparatus comprising means to perform one or more elements of the method 600. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the method 600. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 1102 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

FIG. 7 illustrates a flowchart of a method 700 for operating a base station in a wireless network, according to embodiments herein. The method 700 includes broadcasting 702, from the base station, an indication that the wireless network supports eRedCap UE operation. The method 700 further includes receiving 704, at the base station from a UE, a RACH message. The method 700 further includes scheduling 706, in response to determining, based on the RACH message, that the UE is operating as an eRedCap UE, a PDSCH and a PUSCH for the UE according to a first eRedCap type among a plurality of eRedCap types until the base station determines that the UE is a second eRedCap type.

In some embodiments, the method 700 further comprises receiving, at the base station from the UE, a UE capability message indicating that the UE is either the first eRedCap type or the second eRedCap type.

In some embodiments of the method 700, the second eRedCap type corresponds to a peak data rate reduction, and the first eRedCap type corresponds to the peak data rate reduction and a maximum bandwidth of 5 MHz for PRBs in the PDSCH or the PUSCH.

In some embodiments of the method 700, the RACH message includes a value in an LCID field of an MAC subheader, and the value is to indicate the UE is operating as the eRedCap UE. In some such embodiments, the value in the LCID field corresponds to a CCCH with a size of 48 bits or 64 bits.

Embodiments contemplated herein include an apparatus comprising means to perform one or more elements of the method 700. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 700. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 1118 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

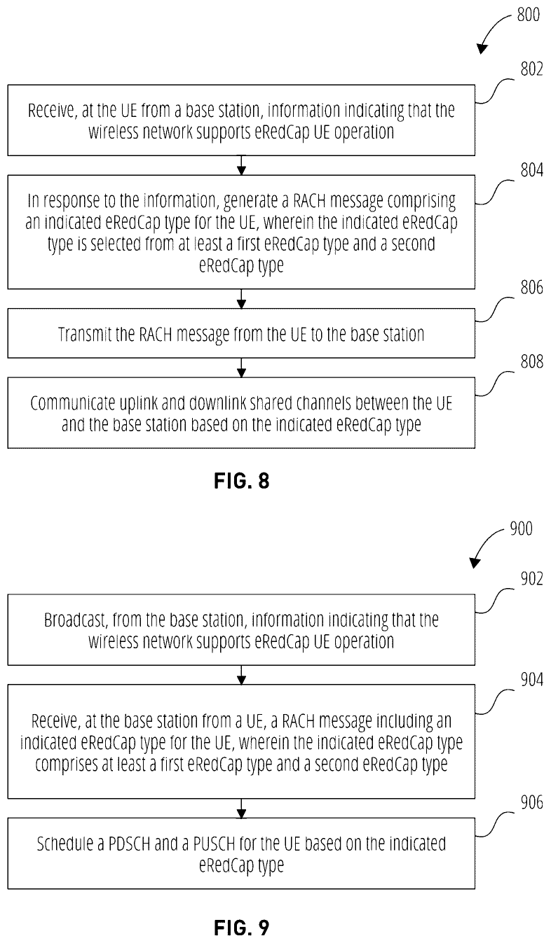

FIG. 8 illustrates a flowchart of a method 800 for a UE to communicate with a wireless network, according to embodiments herein. The method 800 includes receiving 802, at the UE from a base station, information indicating that the wireless network supports eRedCap UE operation. The method 800 further includes generating 804, in response to the information, a RACH message comprising an indicated eRedCap type for the UE. The indicated eRedCap type is selected from at least a first eRedCap type and a second eRedCap type. The method 800 further includes transmitting 806 the RACH message from the UE to the base station. The method 800 further includes communicating 808 uplink and downlink shared channels between the UE and the base station based on the indicated eRedCap type.

In some embodiments of the method 800, the second eRedCap type corresponds to a peak data rate reduction, and the first eRedCap type corresponds to the peak data rate reduction and a maximum bandwidth of 5 MHz for PRBs in a PDSCH or a PUSCH.

In some embodiments of the method 800, the RACH message includes a value in an LCID field of an MAC subheader, wherein the value is to indicate either the first eRedCap type or the second eRedCap type. In some such embodiments the value in the LCID field corresponds to a CCCH with a size of 48 bits or 64 bits. In some such embodiments the LCID field is an eLCID field. Certain such embodiments further comprise setting, by the UE, a non-extended LCID field indicating a RedCap UE operation. Some such embodiments further comprise receiving, at the UE from the base station, an instruction to provide the indicated eRedCap type in a Msg3 RACH transmission; and in response to the instruction, including the value in the LCID field.

In some embodiments, the method 800 further comprises: receiving, at the UE from the base station, an SIB message including a RACH configuration indicating whether to use an LCID or an eLCID for an Msg3 RACH transmission; if the eLCID is configured, using the eLCID to signal the indicated eRedCap type from the UE to the base station; and if the eLCID is not configured, using the LCID to signal the indicated eRedCap type from the UE to the base station.

In some embodiments, the method 800 further comprises receiving, at the UE from the base station, a plurality of BWP configurations with respective eRedCap indication processes, wherein the eRedCap indication processes are based on a logical channel identifier, an extended logical channel identifier, or an Msg3 RACH transmission.

In some embodiments of the method 800, the RACH message comprises one or more reserved bits in an MAC subheader for uplink CCCH transmission, wherein the one or more reserved bits indicate either the first eRedCap type or the second eRedCap type. In some such embodiments, a first reserved bit corresponds to a 48 bit CCCH and a second reserved bit corresponds to a 64 bit CCCH.

Embodiments contemplated herein include an apparatus comprising means to perform one or more elements of the method 800. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the method 800. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1102 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

FIG. 9 illustrates a flowchart of a method 900 for operating a base station in a wireless network, according to embodiments herein. The method 900 includes broadcasting 902, from the base station, information indicating that the wireless network supports eRedCap UE operation. The method 900 further includes receiving 904, at the base station from a UE, a RACH message including an indicated eRedCap type for the UE. The indicated eRedCap type comprises at least a first eRedCap type and a second eRedCap type. The method 900 further includes scheduling 906 a PDSCH and a PUSCH for the UE based on the indicated eRedCap type.

In some embodiments of the method 900, the second eRedCap type corresponds to a peak data rate reduction, and the first eRedCap type corresponds to the peak data rate reduction and a maximum bandwidth of 5 MHz for PRBs in the PDSCH or the PUSCH.

In some embodiments of the method 900, the RACH message includes a value in an LCID field of an MAC subheader, wherein the value is to indicate either the first eRedCap type or the second eRedCap type. In some such embodiments, the value in the LCID field corresponds to a CCCH with a size of 48 bits or 64 bits. In some such embodiments, the LCID field is an eLCID field. In certain such embodiments, the RACH message further includes a non-extended LCID field indicating a RedCap UE operation. Some such embodiments further comprise transmitting, from the base station to the UE, an instruction to provide the indicated eRedCap type in an Msg3 RACH transmission.

In some embodiments, the method 900 further comprises transmitting, from the base station to the UE, an SIB message including a RACH configuration indicating whether to use an LCID or an eLCID for an Msg3 RACH transmission.

In some embodiments, the method 900 further comprises transmitting, from the base station to the UE, a plurality of BWP configurations with respective eRedCap indication processes, wherein the eRedCap indication processes are based on an LCID, an eLCID, or an Msg3 RACH transmission.

In some embodiments of the method 900, the RACH message comprises one or more reserved bits in an MAC subheader for uplink CCCH transmission, wherein the one or more reserved bits indicate either the first eRedCap type or the second eRedCap type. In some such embodiments, a first reserved bit corresponds to a 48 bit CCCH and a second reserved bit corresponds to a 64 bit CCCH.

Embodiments contemplated herein include an apparatus comprising means to perform one or more elements of the method 900. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 900. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a base station (such as a network device 1118 that is a base station, as described herein).

Embodiments contemplated herein include a signal as described in or related to one or more elements of the method 900.

Embodiments contemplated herein include a computer program or computer program product comprising instructions, wherein execution of the program by a processing element is to cause the processing element to carry out one or more elements of the method 900. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

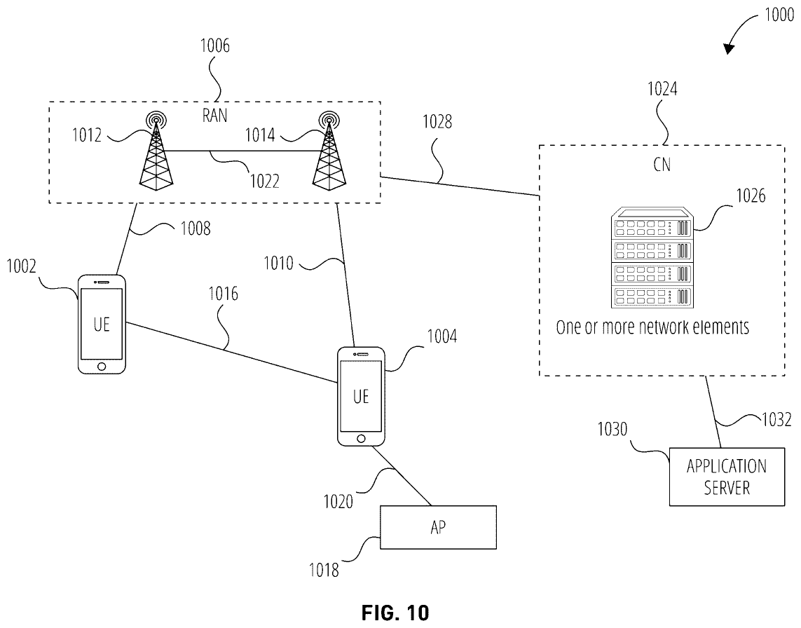

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

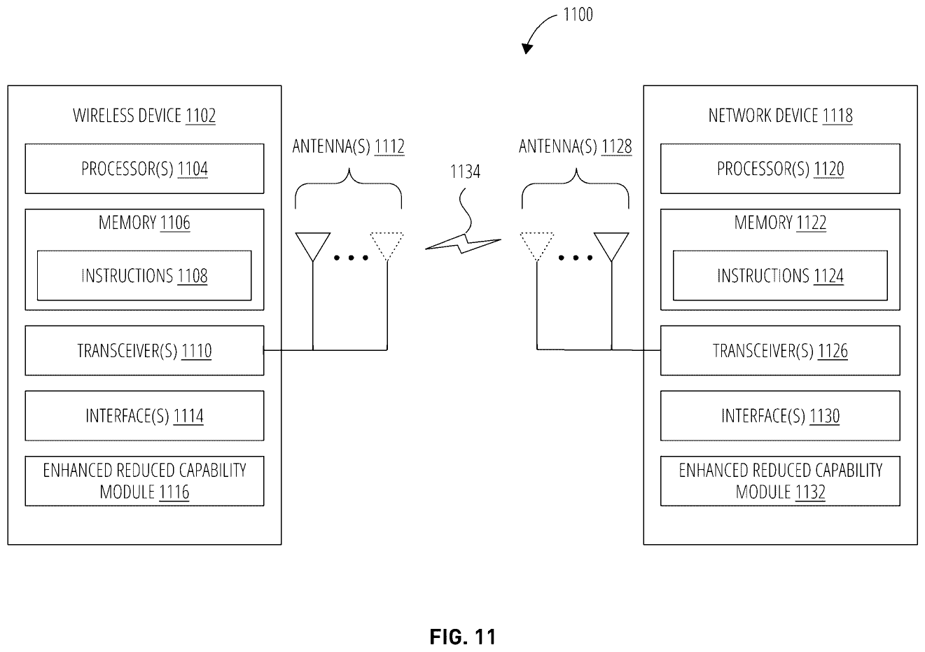

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter circuitry and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include an enhanced reduced capability module 1116. The enhanced reduced capability module 1116 may be implemented via hardware, software, or combinations thereof. For example, the enhanced reduced capability module 1116 may be implemented as a processor, circuit, and/or instructions 1108 stored in the memory 1106 and executed by the processor(s) 1104. In some examples, the enhanced reduced capability module 1116 may be integrated within the processor(s) 1104 and/or the transceiver(s) 1110. For example, the enhanced reduced capability module 1116 may be implemented by a combination of software components (e.g., executed by a DSP or a general processor) and hardware components (e.g., logic gates and circuitry) within the processor(s) 1104 or the transceiver(s) 1110.

The enhanced reduced capability module 1116 may be used for various aspects of the present disclosure, for example, aspects of FIG. 6 and FIG. 8.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter circuitry and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include an enhanced reduced capability module 1132. The enhanced reduced capability module 1132 may be implemented via hardware, software, or combinations thereof. For example, the enhanced reduced capability module 1132 may be implemented as a processor, circuit, and/or instructions 1124 stored in the memory 1122 and executed by the processor(s) 1120. In some examples, the enhanced reduced capability module 1132 may be integrated within the processor(s) 1120 and/or the transceiver(s) 1126. For example, the enhanced reduced capability module 1132 may be implemented by a combination of software components (e.g., executed by a DSP or a general processor) and hardware components (e.g., logic gates and circuitry) within the processor(s) 1120 or the transceiver(s) 1126.

The enhanced reduced capability module 1132 may be used for various aspects of the present disclosure, for example, aspects of FIG. 7 and FIG. 9.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to communicate with a wireless network, the method comprising:
receiving, at the UE from a base station, an indication that the wireless network supports enhanced reduced capability (eRedCap) UE operation;
in response to the indication, performing a random access (RA) procedure and a non access stratum (NAS) registration with the wireless network through the base station; and
providing, from the UE to the wireless network, a UE capability message to indicate the UE as a first eRedCap type among a plurality of eRedCap types.

2. The method of claim 1, wherein the plurality of eRedCap types includes a second eRedCap type corresponding to a peak data rate reduction, and wherein the first eRedCap type corresponds to the peak data rate reduction and a maximum bandwidth of 5 megahertz (MHz) for physical resource blocks (PRBs) in a physical downlink shared channel (PDSCH) or a physical uplink shared channel (PUSCH).

3. The method of claim 2, wherein in response to the indication from the base station that the wireless network supports the eRedCap UE operation, the UE assumes that the base station supports both the first eRedCap type and the second eRedCap type.

4. The method of claim 1, further comprising, during the RA procedure, indicating from the UE to the base station that the UE is operating as an eRedCap UE.

5. The method of claim 4, wherein, at least until the UE provides the UE capability message to the base station, the UE assumes that the base station schedules a maximum bandwidth of 5 megahertz (MHz) for physical resource blocks (PRBs) in a physical downlink shared channel (PDSCH) or a physical uplink shared channel (PUSCH).

6. The method of claim 4, further comprising transmitting, from the UE to the base station during the RA procedure, a random access channel (RACH) message including a value in a logical channel identifier (LCID) field of a media access control (MAC) subheader, wherein the value is to indicate the UE is operating as the eRedCap UE.

7. The method of claim 6, wherein the value in the LCID field corresponds to a common control channel (CCCH) with a size of 48 bits or 64 bits.

8. A method of operating a base station in a wireless network, the method comprising:
broadcasting, from the base station, an indication that the wireless network supports enhanced reduced capability (eRedCap) UE operation;
receiving, at the base station from a user equipment (UE), a random-access channel (RACH) message;
in response to determining, based on the RACH message, that the UE is operating as an eRedCap UE, scheduling a physical downlink shared channel (PDSCH) and a physical uplink shared channel (PUSCH) for the UE according to a first eRedCap type among a plurality of eRedCap types until the base station determines that the UE is a second eRedCap type.

9. The method of claim 8, further comprising:
receiving, at the base station from the UE, a UE capability message indicating that the UE is either the first eRedCap type or the second eRedCap type.

10. The method of claim 8, wherein the second eRedCap type corresponds to a peak data rate reduction, and wherein the first eRedCap type corresponds to the peak data rate reduction and a maximum bandwidth of 5 megahertz (MHz) for physical resource blocks (PRBs) in the PDSCH or the PUSCH.

11. The method of claim 8, wherein the RACH message includes a value in a logical channel identifier (LCID) field of a media access control (MAC) subheader, and wherein the value is to indicate the UE is operating as the eRedCap UE.

12. The method of claim 11, wherein the value in the LCID field corresponds to a common control channel (CCCH) with a size of 48 bits or 64 bits.

13. A method for a user equipment (UE) to communicate with a wireless network, the method comprising:
receiving, at the UE from a base station, information indicating that the wireless network supports enhanced reduced capability (eRedCap) UE operation;
in response to the information, generating a random-access channel (RACH) message comprising an indicated eRedCap type for the UE, wherein the indicated eRedCap type is selected from at least a first eRedCap type and a second eRedCap type;
transmitting the RACH message from the UE to the base station; and
communicating uplink and downlink shared channels between the UE and the base station based on the indicated eRedCap type.

14. The method of claim 13, wherein the second eRedCap type corresponds to a peak data rate reduction, and wherein the first eRedCap type corresponds to the peak data rate reduction and a maximum bandwidth of 5 megahertz (MHz) for physical resource blocks (PRBs) in a physical downlink shared channel (PDSCH) or a physical uplink shared channel (PUSCH).

15. The method of claim 13, wherein the RACH message includes a value in a logical channel identifier (LCID) field of a media access control (MAC) subheader, wherein the value is to indicate either the first eRedCap type or the second eRedCap type.

16. The method of claim 15, wherein the value in the LCID field corresponds to a common control channel (CCCH) with a size of 48 bits or 64 bits.

17. The method of claim 15, wherein the LCID field is an extended LCID (eLCID) field.

18. The method of claim 17, further comprising setting, by the UE, a non-extended LCID field indicating a reduced capability (RedCap) UE operation.

19. The method of claim 15, further comprising:
receiving, at the UE from the base station, an instruction to provide the indicated eRedCap type in a message 3 (Msg3) RACH transmission; and
in response to the instruction, including the value in the LCID field.

20. The method of claim 13, further comprising:
receiving, at the UE from the base station, a system information block (SIB) message including a RACH configuration indicating whether to use a logical channel identifier (LCID) or an extended logical channel identifier (eLCID) for a message 3 (Msg3) RACH transmission;
if the eLCID is configured, using the eLCID to signal the indicated eRedCap type from the UE to the base station; and
if the eLCID is not configured, using the LCID to signal the indicated eRedCap type from the UE to the base station.

21. The method of claim 13, further comprising receiving, at the UE from the base station, a plurality of bandwidth part (BWP) configurations with respective eRedCap indication processes, wherein the eRedCap indication processes are based on a logical channel identifier (LCID), an extended logical channel identifier (eLCID), or a message 3 (Msg3) RACH transmission.

22. The method of claim 13, wherein the RACH message comprises one or more reserved bits in a media access control (MAC) subheader for uplink common control channel (CCCH) transmission, wherein the one or more reserved bits indicate either the first eRedCap type or the second eRedCap type.

23. The method of claim 22, wherein a first reserved bit corresponds to a 48 bit CCCH and a second reserved bit corresponds to a 64 bit CCCH.

24. A method of operating a base station in a wireless network, the method comprising:
broadcasting, from the base station, information indicating that the wireless network supports enhanced reduced capability (eRedCap) UE operation;
receiving, at the base station from a user equipment (UE), a random-access channel (RACH) message including an indicated eRedCap type for the UE, wherein the indicated eRedCap type comprises at least a first eRedCap type and a second eRedCap type; and
scheduling a physical downlink shared channel (PDSCH) and a physical uplink shared channel (PUSCH) for the UE based on the indicated eRedCap type.

25. The method of claim 24, wherein the second eRedCap type corresponds to a peak data rate reduction, and wherein the first eRedCap type corresponds to the peak data rate reduction and a maximum bandwidth of 5 megahertz (MHz) for physical resource blocks (PRBs) in the PDSCH or the PUSCH.

26. The method of claim 24, wherein the RACH message includes a value in a logical channel identifier (LCID) field of a media access control (MAC) subheader, wherein the value is to indicate either the first eRedCap type or the second eRedCap type.

27. The method of claim 26, wherein the value in the LCID field corresponds to a common control channel (CCCH) with a size of 48 bits or 64 bits.

28. The method of claim 26, wherein the LCID field is an extended LCID (eLCID) field.

29. The method of claim 28, wherein the RACH message further includes a non-extended LCID field indicating a reduced capability (RedCap) UE operation.

30. The method of claim 26, further comprising transmitting, from the base station to the UE, an instruction to provide the indicated eRedCap type in a message 3 (Msg3) RACH transmission.

31. The method of claim 24, further comprising transmitting, from the base station to the UE, a system information block (SIB) message including a RACH configuration indicating whether to use a logical channel identifier (LCID) or an extended logical channel identifier (eLCID) for a message 3 (Msg3) RACH transmission.

32. The method of claim 24, further comprising transmitting, from the base station to the UE, a plurality of bandwidth part (BWP) configurations with respective eRedCap indication processes, wherein the eRedCap indication processes are based on a logical channel identifier (LCID), an extended logical channel identifier (eLCID), or a message 3 (Msg3) RACH transmission.

33. The method of claim 24, wherein the RACH message comprises one or more reserved bits in a media access control (MAC) subheader for uplink common control channel (CCCH) transmission, wherein the one or more reserved bits indicate either the first eRedCap type or the second eRedCap type.

34. The method of claim 33, wherein a first reserved bit corresponds to a 48 bit CCCH and a second reserved bit corresponds to a 64 bit CCCH.

35. An apparatus comprising means to perform the method of any of claim 1 to claim 34.

36. A computer-readable media comprising instructions to cause an electronic device, upon execution of the instructions by one or more processors of the electronic device, to perform the method of any of claim 1 to claim 34.

37. An apparatus comprising logic, modules, or circuitry to perform the method of any of claim 1 to claim 34.
